(19) United States
(12) Patent Application Publication
(10) Pub. No.: US 2015/0300810 A1
(43) Pub. Date: Oct. 22, 2015

(54) A METHOD OF NON-CONTACT MEASURING OF OUTER DIMENSIONS OF CROSS SECTIONS OF METALLURGICAL ROD MATERIAL AND A MODULAR FRAME FOR PERFORMING THEREOF

(71) Applicant: VYSOKÁ SKOLA BÁNSKÁ - TECHNICKÁ UNIVERZITA OSTROVA, Ostrava Poruba (CZ)

(72) Inventors: David FOJTÍK, Markvartovice (CZ); Petr CERNAVA, Havírov-Prostrední Suchá (CZ)

(73) Assignee: VYSOKÁ SKOLA BÁÑSKÁ- TECHNICKÁ UNIVERZITA OSTRAVA, Ostrava Poruba (CZ)

(21) Appl. No.: 14/438,836

(22) PCT Filed: Sep. 30, 2013
(86) PCT No.: PCT/CZ13/00120

§ 371 Date: Apr. 27, 2015

(30) Foreign Application Priority Data
Sep. 30, 2013 (CZ) PV 2013-762

(51) Int. Cl. G01B 11/10; G01B 11/245

(52) U.S. Cl. CPC G01B 11/105; G01B 11/245

(57) ABSTRACT

A method of continuous non-contact outer dimensions measuring of cross sections of metallurgical rod material consists in the following technical solution: at least three laser beams rotating in the same direction or oscillating laser beams of commonly calibrated and synchronized scanners evenly surround rod material so that the centres of the beams are aimed at the axis of the rod material repeatedly measuring the distance between the beginning of the coordinate systems of scanners and the surface of the scanned rod material; then the group of simultaneously measured distances is converted to point coordinates of the common coordinate system; using the groups of the common coordinate system, diameters and centres of gravity of the cross section of the rod material in the scanning plane are calculated; based on approximation of changes of the centres of gravity of the rod material in time, at least one function of the cross movement is determined during profile scanning and using the function/s of the cross movement of the rod material during one beam deflecting cycle the coordinates are converted of the measured points of the corresponding profile to eliminate the cross movement and offsetting of rod material during one scanning sequence in order to obtain the actual profile of rod material. The basis of the modular frame fitted with at least one scanner and wiring according to the invention consists in it having a polygonal shape with vertexes formed by at least one connecting elbow and at least two anchoring elbows, whereas these connecting elbows and anchoring elbows are connected by connecting arms and these arms are fitted (using sleeve fixtures) with protective housings for the scanners and the modular frame carries a distribution system for at least one cooling medium.

### TECHNICAL FIELD

The invention concerns a method of non-contact measuring of outer dimensions of cross sections of metallurgical rod material typically even during production and a modular frame allowing implementation of this measuring method.

### STATE OF THE ART

The quality of production of metallurgical rod material, in particular tubes, is assessed based on many production parameters including outer cross section (diameter) and ovality, which are also specified by European standard EN 13 508. These parameters are crucial particularly in production of hot-rolled seamless steel tubes. Due to this production technology, diameter and ovality are monitored continually along the whole tubes length; moreover, possible surface defects are detected, which may also indicate a defect of the rolling mill. Tubes need to be measured as soon as possible, ideally immediately after the rolling mill during their production, so that any defects may be corrected in time and thus the loss of material and power may be minimized. This also requires measuring of hot tubes with temperatures designed for their forming (approximately 1.000° C.). In order to indicate correctly the cause of a defect, operators or inspectors need detailed data of the tube and a tool which would allow them a detailed analysis of the ascertained deformation. It is also often required that these data be stored (at least throughout the warranty period) for the purposes of long-term production analysis or as a support means in case of claim procedures.

When measuring rolled tube diameters, contact or non-contact methods are used.

The former group includes methods based on applying on the tube or gripping it by means of contact adjustable elements of mechanical gauges, which provide the diameter value directly or by conversion. An authorised person usually carries out manual measuring. The advantage is its simplicity and low cost. The disadvantage is a very low speed and a very low number of implemented measurement actions, which excludes continuous evaluation of ovality or creating records for detailed analyses. Measuring of hot tubes is also complicated or outright impossible, which causes substantial delay of measuring in relation to the production. In general, these methods are regarded as out-of-date and unsatisfactory.

The other group includes non-contact measuring methods based on optical technology, which allow completely automatic measuring at high speeds including making of records.

A shadow method is based on the principle of evaluation of a shadow cast by a lit object (tube). This method places a transmitter (with a parallel light beam with plane wave) against a receiver evaluating the light from the transmitter. The measured tube is placed between these two elements, so that its axis is perpendicular to the wave front. The tube screens a portion of the transmitted light on the receiver, which evaluates the length of the shadow representing the diameter of the tube. The advantage of this method is a high precision, which in laboratory conditions may be up to micrometers (in the case of production by forming such precision may not be even used). The disadvantage is measuring of only one diameter at the section of the plane passing through the tube axis being perpendicular to the plane of the light beam coming from the transmitter. This deficiency is eliminated by using several measuring units at the same time, which surround the tube in a plane perpendicular to the tube and thus create a ring through which the tube passes. In practice then, up to six units spread by 30 degrees may be used, which allows measuring of six diameters at the same time. The portion not covered is then checked by turning or oscillation of the ring. The disadvantage of such solution are the spatial requirements, inability to discover deep longitudinal cuts and also a relatively high purchase price and operating costs. By reducing the number of measuring units or by leaving out oscillation, the price is reduced but so is the coverage of the measured tube and there is an increase of potential inaccuracy of ovality calculation or the possibility of missing of some surface defects. The method is unable to detect even very deep cuts running along tube axis.

The method of measuring of diameters by means of triangulation laser range finders consists in even placing of several pairs of triangulation laser range finders along the circumference of a ring surrounding the measured tube, so that the beam of each range finder is aimed at the tube axis and together these beams are in a plane perpendicular to the tube axis. When tubes are passing through the ring, each of the range finders measures the distance from the surface of the tube and using pairs of synchronized range finders facing each other the diameter is acquired. The number of diameters measured at once depends on the number of range finder pairs. In practice, up to 36 range finders (LIMAB—TubeProfile) are used, which are placed at ten-degree intervals. The portion not covered is then checked by turning or oscillation of the ring. The disadvantage of this solution is the need of a very stable tube route, so that its axis is always between a pair of laser range finders. In the case of a vertical movement of a tube, the issue is solved by dynamic deviation of the ring with range finders in the measuring plane, so that it copies the vertical movement of a tube. Compared to the proposed solution this method offers a substantially lower number of measured surface points together with a high purchase price and maintenance costs.

Another method is measuring using triangulation laser scanners and evaluation of scanned surfaces. This method usually uses laser triangulation scanners arranged in a ring, which project a line on the tube surface in a plane perpendicular to its axis using diffraction of laser beams. Scanners are placed in pairs so that the projected segments of lines form a fully surrounding line on the measured tube. Pairs of scanners are placed opposite each other and they are synchronized. At the same time, each scanner reads the projected image on the tube and then evaluates the scanned part of the tube surface. The pairs of recorded bends are connected into one image which is used for evaluation of the diameter. Each scanner thus scans a part of the tube, which the respective software connects with the others into one comprehensive image presenting the profile of the tube at the given scanned cross section. This image is used for evaluation of diameters and deformations are ascertained. The disadvantage of this method is in principle scanning of the image of the projected line, when the image is evaluated at once, whereas the image acquired at once has a different quality in the centre of the scanned image than on the edges. The reason for that is the shape of the tube—towards the centre the angle of laser beam impact changes together with the intensity of the reflected image. The image has some properties in the centre of the scanned line and different on the edges, which makes evaluation more complicated. Due to this fact the angle of scanner coverage is relatively low, which in the case of scanning of the whole tube circumference results in the need of a greater number of scanners and therefore even a higher price of this solution. A solution to these drawbacks may be replacing of the scanner projecting a line with a scanner scanning the reflected steered beam point by point. However, in the case of occurs a problem with vertical oscillation of tubes, when the scanned curve also includes the movement of the tubes. Thus, this principle may not be applied to tubes with substantial vertical movement.

In order to implement the above-mentioned non-contact measuring methods, massive inadaptable frames are used fitted with light sources, lasers or scanners, which require a lot of space. In a number of cases frames are installed to the existing production lines and their installation requires substantial efforts and additional costs added to the actual acquisition costs, as the production line needs to be shut down as well. In order to secure perfect measuring conditions, most measuring methods require that the frames may revolve around its own axis, which further makes the design and installation of frames more complex and as a result frames tend to be more prone to breakdowns as well.

### SUMMARY OF THE INVENTION

In consequence of these facts, the objective of the invention is to propose a method of non-contact measuring of outer diameters of cross sections of metallurgical rod material, which would remove the above-mentioned disadvantages and would allow reliable measuring of required parameters even in the case when the measured material moves or vibrates vertically during measuring. Further, the objective of the invention is to create equipment which would allow implementation of this measuring method and would be both flexible and easy for installation.

The method of continuous non-contact measuring of outer dimensions of cross sections of metallurgical rod material consists in the following steps:
at least three uniformly rotating or oscillating laser beams of commonly calibrated and synchronized scanners symmetrically surrounding the rod material so that the central positions of beams are directed at the axis of the rod material, repeatedly measuring the distance between the beginning of the coordinate systems of the scanners and the surface of the scanned rod material;
a group of distances measured at the same time is converted to coordinates of points in the common coordinate system;
using the group of points in the common coordinate system, diameters and the centre of gravity (centre) of the rod material in the scanning plane are calculated;
based on approximation of changes of rod material centres of gravity over time, at least one function of cross movement of the rod material during scanning is determined;
using the function/s of the cross movement of rod material during one cycle of deflection of beams, the coordinates of the measured points of the corresponding cross section are converted to eliminate the cross movement and offsetting of rod material during one scanning sequence in order to acquire actual cross section of rod material.

Based on the known or measured travel speed of rod material, the position of the scanned cross sections may be preferably determined including the overall length of rod material.

In order to eliminate the effect of thermal expansion of rod material, surface temperature of rod material is measured preferably for each segment together with measuring of the distance between the beginning of the coordinate systems of scanners and the surface of scanned rod material; and the temperature is used for conversion of the dimensions of rod material from hot to cold conditions.

The distances between the beginnings of coordinate systems of scanners and the surface of scanned rod material are typically measured using triangulation methods or by evaluation of phase shift of the reflected modulated signal of laser beam.

The method is described in detail below:

The essence of the invention is the method of continuous non-contact measuring of outer dimensions, ovality, and scanning of a 3D model of rod material. This method which may be applied directly during production or even during additional inspection, is suitable for various types of rod material but the best results are achieved when measuring rod material with oval cross section and other metallurgical material with axially symmetrical cross section (typically tubes or round bars), when it is possible to measure their ovality with high accuracy. Rod material (hereinafter also tubes or bars) pass along their axis perpendicularly to the scanning plane, which is formed by at least three uniformly rotating or oscillating laser beams of commonly calibrated and synchronized scanners symmetrically surrounding the measured rod material so that the central positions of the beams are directed at the rod material axis. Scanners are evenly spread around the circumference of the rod material so that their scanning planes form together a plane perpendicular to its axis and each scanner is turned so that it scans the determined part of the sector of the rod material cross section. Together, the scanning sectors scan the overall or partial cross section of the rod material. Scanners need to be in pairs directed at each other. Scanners, which are typically arranged on a fixed frame surrounding the measured rod material and use a steered laser beam and a sensor, repeatedly scan the cross section of the passing rod material along the scanning plane by carrying out within one deflection cycle of beams periodically repeated synchronous measurements of distances between the beginnings of scanner coordinate systems and the surface of the scanned rod material using a triangulation method or evaluation of the phase shift of the reflected modulated signal of the laser beam.

Each distance measuring is carried out synchronously on all scanners, which for each cycle renders a group of simultaneously measured distances, which are converted to coordinates of points in the common coordinate system. Following the application of a filter, the group of the measured points in the common coordinate system is used for calculation of diameters and the centre of gravity (centre) of the rod material in the scanning plane. During one deflection cycle of laser beams we thus acquire a comprehensive set of points, which represent the overall scanned cross section usually also burdened with cross movement of rod material. The function of cross movement of rod material during scanning of one cross section is determined individually based on approximation of changes of centres of gravity of rod material in time.

As an option, movement of the longitudinally shifted centre of gravity of the cross section in another singular or multiple measuring planes parallel to the scanning plane shifted by a known distance is evaluated for the same time interval. Evaluation of the centre of gravity in these planes is carried out synchronously with measuring in the scanning plane by at least three scanners using the same method as in the scanning plane, or these are replaced by at least three commonly calibrated laser range finders placed along the circumference of rod material in the measuring plane so that their beams are directed to the centre of the rod material and these measure the distance between the beginning of the laser range finder and the surface of rod material. Again, groups of at least three points of the cross section of a rod material cross section are acquired in the measuring plane, of which the function of the change of the centre of gravity in time is evaluated using the same technique as in the scanning plane. The function of the change of a shifted centre of gravity in time may be replaced by a firmly defined point located on the intersection of the axis of rod material and the nearest plane in which no cross movement occurs due to firm guiding of rod material.

Using the functions of the cross movement of the measured rod material during one cycle of deviation of beams, the coordinates of the measured points of the corresponding cross section are converted to eliminate the cross movement and offsetting of rod material during one scanning sequence and thus the actual cross section of rod material is acquired in the scanning plane, which is ideally perpendicular to its axis.

Based on the known or measured travel speed (using Doppler laser or an optical movement sensor or camera system) of the rod material, the position of the scanned cross sections and also the overall length of the rod material is determined. At the same time, temperature of the rod material is measured for each segment, which is then input as information for conversion of the dimensions of rod material from a hot to cold condition.

All scanned cross sections and knowledge of their positions are then used for forming of a 3D model of the measured rod material and diagrams of changes of diameter or ovality and other calculated values. Recorded points may be archived in a data storage (database or file system), from where they are reconstructed using a special application and visualised including a 3D model of rod material, the course of changes of monitored values, detailed view of individual scanned cross sections, marked diameters and ascertained defects.

The main advantage of this invention is the ability of detailed measuring of external dimensions of cross sections and even ovality of rod material along its length and detailed scanning of the whole surface allowing revealing of various surface defects directly on the production line during transporting or rolling of rod material in hot conditions (up to 2400° C.), and vibration of rod material.

A very significant advantage is the ability to measure safely rod material, which oscillates during its movement in cross directions provided that the oscillation frequency is not greater than one half of the frequency of scanner laser beam steering and the deviation does not exceed the scanned field of the scanners. At the same time the method is able to eliminate offsetting of rod material when the scanning plane is not ideally perpendicular to the axis of rod material.

Last but not least, the advantage of this solution is the ability to scan a detailed 3D model of rod material surface, which is archived and may be reconstructed at any time later in an analytical application where detailed analyses may be implemented of rod material shape precision.

Another significant characteristic of the solution is the design of the modular frame by which the required position of individual scanners is secured when measuring the required parameters.

The basis of the modular frame fitted with at least one scanner and wiring according to the invention consists in it having a polygonal shape with vertexes formed by at least one connecting elbow and at least two anchoring elbows, whereas these connecting elbows and anchoring elbows are connected by connecting arms and these arms are fitted (using sleeve fixtures) with protective housings for scanners and the modular frame carries a distribution system for at least one cooling medium. Besides the connecting function, the anchoring elbows have a specific function of securing firm anchoring of the modular frame. Preferably, these anchoring elbows are placed in the modular frame always in such a way so that their longer sides (arms) are vertically oriented. There are anchoring brackets welded on the longer sides for anchoring of the modular frame. The frame creating a closed ring of a polygonal shape (most often an irregular octagon) may have simple or double construction. By selecting the connecting and anchoring elbows (their angles) and the lengths of connecting arms, which are connected by demountable most often gripping (or strutting) connections or permanent connections (welded, glued or brazed), it is possible to make a modular frame which allows arbitrary symmetric or asymmetric placement of scanners. By changing the lengths of connecting arms and types of transition parts (connecting elbows) the shape and size of the frame changes and adapts to any production line environment. Owing to the above mentioned characteristics and the possibility to select the required number of scanners as necessary, it is possible to scan arbitrary segments of the measured tube. The most often used angles for standardized connecting elbows are 120°, 135°, 150° and 144°. A measured tube then passes through the modular frame in the direction of its axis perpendicularly to the scanning plane which is formed by the steered beams of at least three scanners.

Inside the modular frame circulates preferably at least one cooling medium which keeps the frame within an admissible temperature range. Supply of the cooling medium into the modular frame is secured by a cooling medium inlet which is preferably arranged on the anchoring elbow. Air and/or cooling liquid may be used as the cooling medium. Moreover, in the environment with high ambient temperatures, the modular frame (which is made of high-strength steel with low thermal expansion) is preferably protected by thermally insulating material, so together with cooling the modular frame is kept in an admissible temperature range at which thermal expansion of the frame may be disregarded. The outlets of the cooling medium which distribute the cooling medium to the protection cases for scanners are preferably arranged on the connecting elbows. Cooling of a scanner in its housing is preferably secured by a liquid cooler connected to the distribution system of the medium of liquid cooling and/or air streams. Moreover, air streams prevent contamination of the optical part of a scanner. Preferably, distribution systems, i.e. air distribution system, liquid medium distribution system and/or wiring are routed on the external edge of the modular frame or even better inside the modular frame. Even more convenient is their protection by a robust strip which is attached to the modular frame and is easily demountable.

A protective housing protects each scanner against mechanical damage, fouling of the optical part of the scanner, and external heat. The protection housings are attached to a rugged simple or double frame of the modular structure attached by rugged sleeves with holders, which provide adjustability and turning along and around frame sides. The sleeve allows easy fastening of scanners anywhere along the frame circumference and thus it is possible to modify the system for a system with a various number of scanners. An adjustable part is placed between the sleeve and the housing as necessary which allows turning of the protection case with a scanner along the scanning plane around the centre of the scanning sector and positioning it towards the axis of rod material. Preferably, the protective housing Housing further contains fine adjusting elements by which it is possible to turn and position scanners in all three axes with a great precision and a limited range. In this way then, the required position of scanners towards the measured tube is secured. The scanner is cooled down inside a protection housing by a water cooling system and the optical part is cooled down by two independent air streams, which moreover protect the optical part against contamination.

Preferably, at least one pyrometer may be placed on the modular frame, which measures surface temperature of rod material. Further, the modular frame may be fitted with a speed sensor of tube travel, which is used in the case that tube speed fluctuates or it is impossible to ascertain tube speed otherwise. If the travel speed of the measured tube is constant and known, measuring of speed is not necessary and is defined as an input value (variable) of the evaluation software.

The frame is at the same time used for distribution of a cooling medium, which is either air or a cooling liquid. Moreover, in the environment with a high ambient temperature, the modular frame is protected by thermally insulating material, so together with cooling, the modular frame is kept within an admissible temperature range, at which thermal expansion of the frame may be disregarded.

One of the advantages of the proposed equipment consists in the combination of a relatively low price and high modularity depending on required accuracy of measuring and the scanning detail. For reasons of simple production and assembly, the modular frame is designed as a polygon with straight sides, preferably made of tubes (round cross section). The arms formed by tubes are convenient for assembly as they may be turned arbitrarily when they are connected. The tubes are also available in various designs and their production is simple, so their use reduces the overall costs of the modular frame. The system may be extended at any time with other scanners and thus the accuracy and detail of measurement may be increased with minimum additional costs. Modular tube design of the frame allows symmetrical and asymmetrical spreading of the required number of scanners (usually ranging from 3 to 12) depending on the range of diameters of measured tubes and available space.

Another significant advantage is the robustness of the solution with minimum moving parts and the system is able to function with as few as three scanners, i.e. it is possible to operate the system to a limited extent when some scanners break down provided that at least three scanners are still operational.

Another advantage of the solution is resistance to high temperatures of rolled material (up to 2400° C.) and pollution of the surrounding environment caused by the production environment due to efficient cooling of scanners and the frame and modelling of air stream which prevents contamination of optical part of scanners.

Another significant advantage is also a low space requirement and modular frame design, which allows adjusting of the frame to the actual environment, which helps to reduce costs of modification of the existing production lines.

A robust protection housing including scanner liquid cooler is attached to a holder. At the same time the housing brings and shapes two independent air streams which suitably blow on the scanner sights and thus cool them down and protect them against fouling. The housing also contains a mechanically adjustable attaching of scanners with a locking system by which it is possible to turn the scanners very precisely within a limited range in all directions. Cabling, air, and water distribution systems are placed either inside the frame or along the circumference of the frame protected by robust strips. The modular frame itself consists of piping for the cooling medium—either a cooling gas or liquid. Moreover, in the environment with a high ambient temperature, the modular frame is protected by thermally insulating material, which together with cooling keeps the frame within an admissible range of temperatures, at which the effects of thermal expansion on the accuracy of measurements may be disregarded.

Two air sources and one source of cooling liquid are placed in an accessible distance to the frame. Cooling liquid is supplied in piping from the air conditioning system to the frame where it passes through the scanner coolers placed in housings and flows back in a closed loop to the cooling system.

### BRIEF DESCRIPTION OF THE DRAWINGS

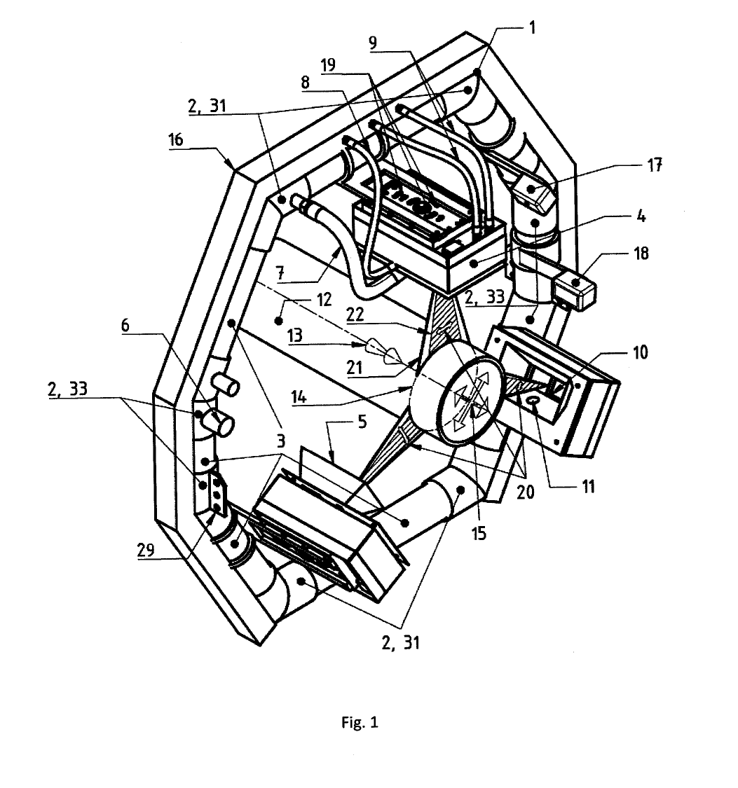

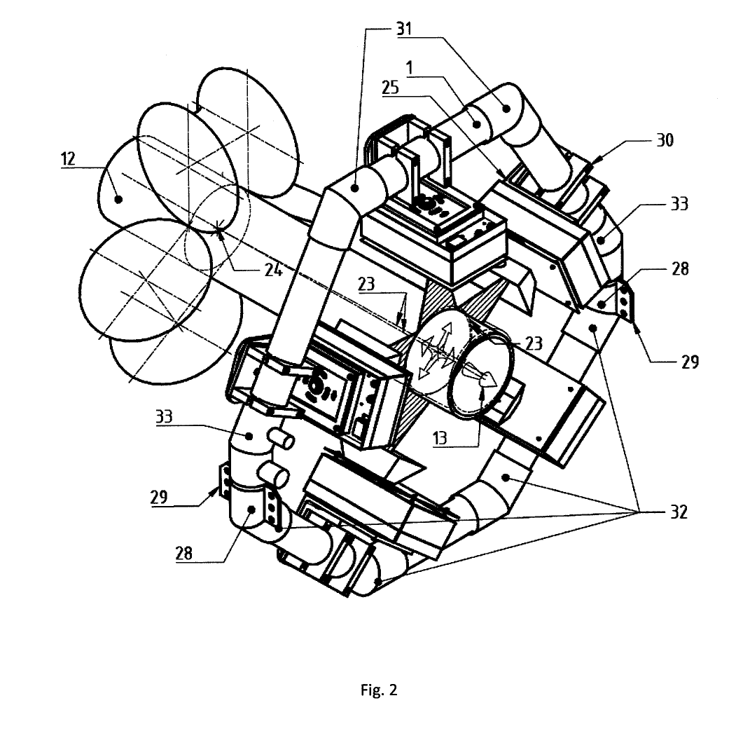

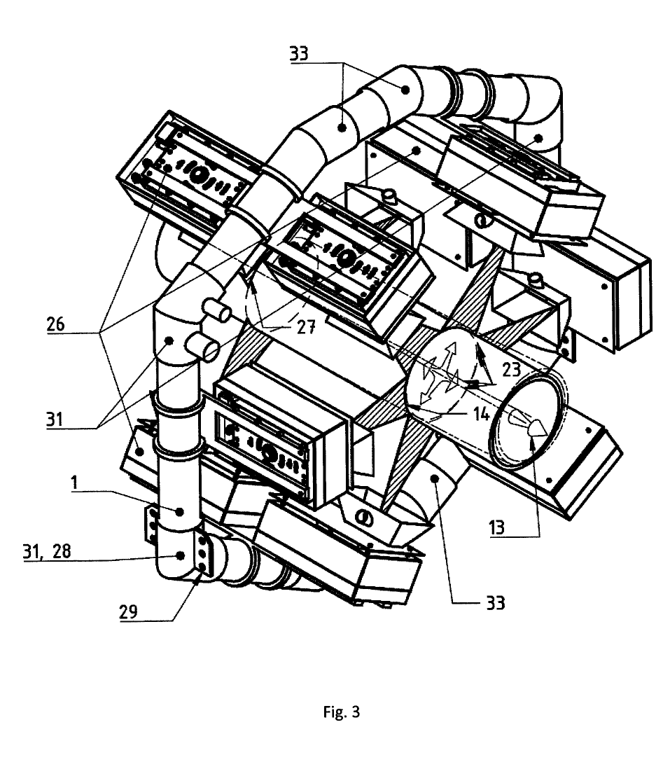

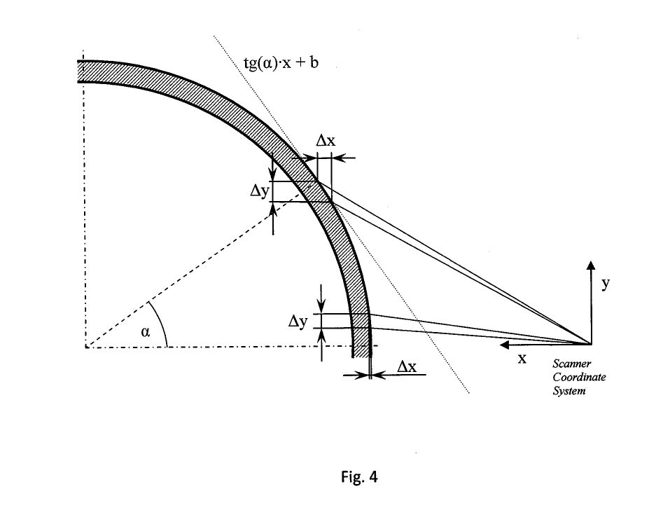

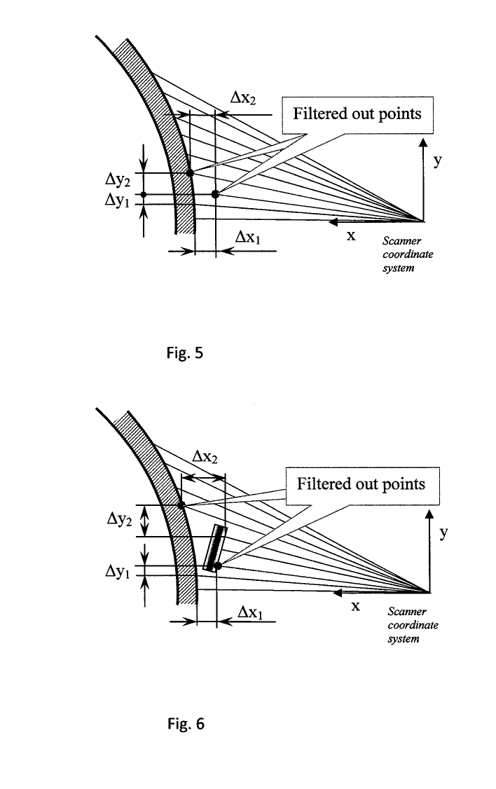

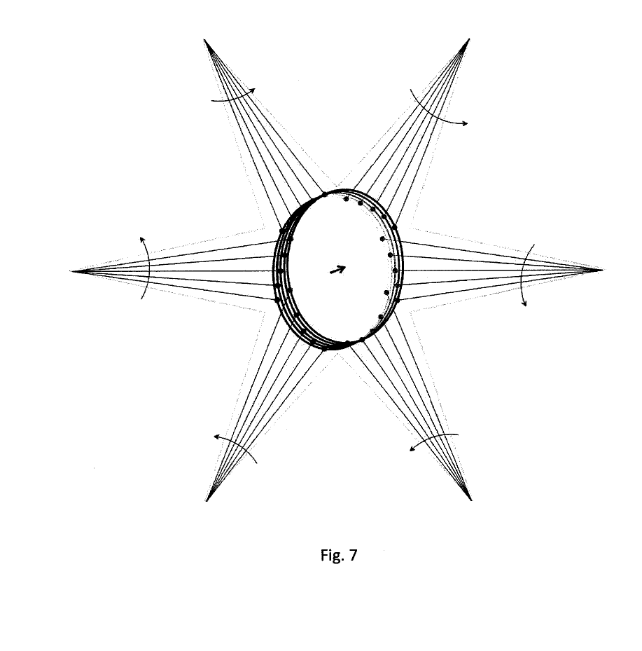

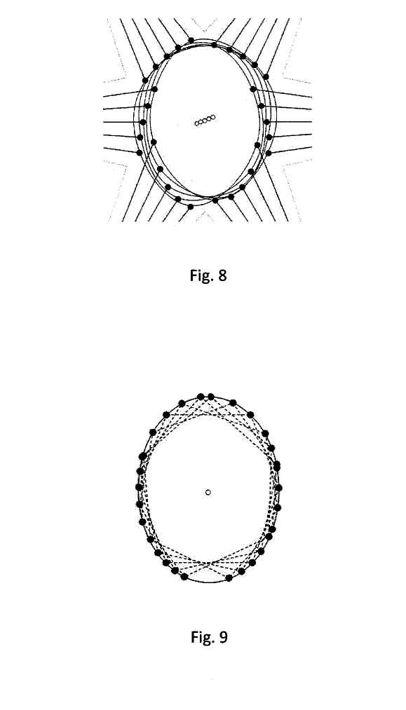

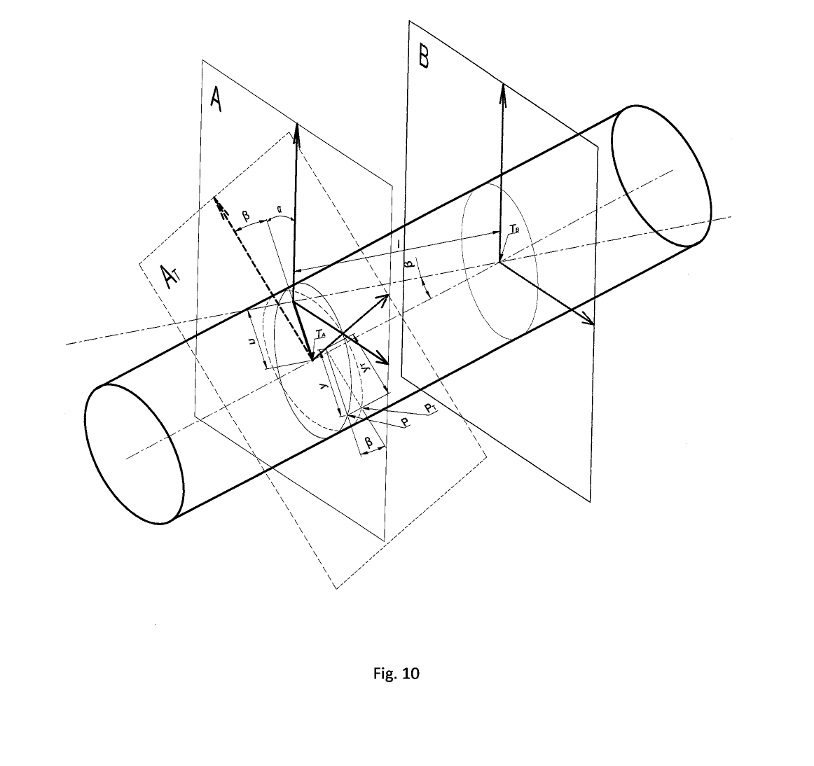

The invention is described in a greater detail in particular embodiments using attached images. FIG. 1 shows implementation of the modular frame with a basic three-scanner design with a protection strip along frame circumference; FIG. 2 shows a five-scanner frame design indicating the sets of rollers of the rolling mill, and FIG. 3 shows a six-scanner frame design provided with further three laser scanners in the secondary measuring plane. FIG. 4 then shows determination of filter value of tangent points, FIG. 5 shows filtered points in the case of erroneously measured singular point, FIG. 6 shows filtered points in the case of erroneously scanned large object, FIG. 7 shows a set of points acquired during one deflection cycle of laser beams affected by cross movement of the measured tube, FIGS. 8 and 9 show elimination of cross movement by gradual calculation of centres of gravity from groups of simultaneously measured points (FIG. 8) and by shifting these groups to the common centre of gravity (FIG. 9) and FIG. 10 shows the principle of elimination of skew routing of tubes into the scanning plane.

### Exemplary Embodiments of the Invention

All embodiments of the invention below use a modular concept of the tubular frame 1, securing the required position of scanners towards the measured tube 12. The tubular frame 1 is made of high-strength steel with low thermal expansion, it is provided with insulation and it is cooled by air or water. A cooling medium circulates inside the frame which keeps the frame within permissible temperature range so that the effect of material thermal expansion may be disregarded. The measured tube 12 passes through the tubular frame 1 in the direction 13 of its axis perpendicularly to the scanning plane 14 which is formed by the steered beams of at least three scanners. The frame structure creates a polygonal ring (in practice usually an irregular octagon) with the sides made of connecting tubes 3 mutually connected by connecting elbows 2 (angle connectors). By selecting the connecting elbows 2 and the lengths of connecting tubes 3, it is possible to assemble a tubular frame 1, which allows arbitrary symmetric or asymmetric positioning of scanners for scanning of any segments of the measured tube 12. The connecting elbows 2 are typically prefabricated and connect the connecting tubes 3 forming the sides of the frame under specified angles (the basic angles are 120°, 135°, 150° and 144°) so that the connecting elbows 2 form sockets into which pipe ends 3 are inserted. Joints are either demountable (most often gripping or strutting connection) or non-demountable (welded, glued or brazed). At least two anchoring elbows 28 have beside the connecting function also the specific function of securing fixed anchoring of the tubular frame 1 and supply of cooling medium into the tubular frame 1. These anchoring elbows 28 are placed in the tubular frame always with their longer sides vertically oriented. Brackets 29 are welded on the longer sides of anchoring elbows and the inlet 6 of the cooling medium (air) is placed there. Other connecting elbows may be provided with an outlet 7 of the cooling medium (air) distributing the cooling medium into the protection housings 4 of scanners. The protective housing 4 protects each scanner against mechanical damage, fouling of the optical part of the scanner, and external heat coming most often from the rolled tubes. The protective housings 4 are attached to the tubular frame 1 by means of holders with sleeves 30—either directly to the sides of the tubular frame or via an adjustable part 25 allowing basic turning of a scanner in the scanning plane. The protective housing 4 contains fine adjusting elements 19 for accurate positioning of the scanner including a locking mechanism, by which it is possible to turn scanners in all three axes with a great precision and a limited range and thus position scanners accurately.

Scanner cooling in the housing is secured by a liquid cooler connected to the distribution system 9 of the medium of liquid cooling and two streams of independent air, which besides cooling also prevent contamination of the optical part of the scanner. The first stream is filtered and in the form of a modelled flow from the blow nozzle 10 of the optical part of the scanner blows directly on the sights of the optical parts of scanners. The second not filtered routed air stream from the cooling nozzle 11 of the scanners blows on and cools down the thermal and screening shield 5 and increases the efficiency of scanner protection against fouling. The second air stream is distributed directly by the tubular frame 1 connected on one side to the inlet 6 of the cooling medium (air) and on the other side to the outlet 7 of the cooling medium (air), whereas the actual tubular frame 1 is at the same time cooled down by this air. Other distribution systems, i.e. distribution system 8 of service (filtered) air and the distribution system 9 of liquid cooling medium are routed together with electric wiring on the edge of the tubular frame 1 and are protected by a massive protection strip 16. The protection strip 16 is typically a channel and is attached in a demountable manner to the tubular frame 1, e.g. by means of steel tapes encircling the connecting tubes 3 of the tubular frame 1 or by a screwed connection to the connecting or anchoring elbows 2, 28.

All frame variants also include at least one pyrometer 17 placed on the tubular frame which measures the surface temperature of tubes. All frame variants may be further fitted with a speed sensor 18 of tube travel, which is used in the case that tube speed fluctuates or it is impossible to ascertain tube speed otherwise. If the travel speed of the measured tube 12 is constant and known, measuring of speed is not necessary and is defined as an input value (variable) of the evaluation software.

The values stated in the following description of example implementation are applied if scanners are used with the measuring range of the scanning beam 200-700 mm and the maximum angle of the scanning sector 50°, with the guaranteed precision up to ±0.1 mm and resolution 0.1 mm when sensing areas, which are tilted compared to the beam maximally at 45° and with reduced accuracy±0.15 mm when scanning surfaces which are tilted towards the beam maximally at 40 g. The density of scanned points (point pitch) along the circumference of the profile perpendicularly to the tube axis applies to scanners with the measuring frequency 2 kHz and scanning frequency 10 Hz. The minimum point density along the tube dx depends on the travel speed of the tube and scanning frequency of scanners. For example, if the travel speed of a tube is 0.5 ms⁻¹ and the scanning frequency is 10 Hz, the longitudinal pitch between points is 50 mm, or if the travel speed of the tube is 0.3 ms⁻¹ and the scanning frequency is 30 Hz, the longitudinal pitch between points is 10 mm.

A first exemplary embodiment is presented by a tubular frame 1 in a basic three-scanner design shown in FIG. 1, with graphically depicted protection strip 16 along the circumference of the tubular frame 1. This is the cheapest variant suitable for basic scanning and measuring of diameters of measured tubes 12, for which it is not necessary to measure and scan in detail the whole profile but maximally three measured sectors 22 (monitoring of defects at places of interspace between rollers of the rolling mill, monitoring of welds, etc.). Scanning beyond the measured sectors 22, i.e. in sector 19 of oscillating or rotating laser beams of the scanner, or scanning sector 20 is not used for measuring of diameter and calculation of ovality but only for visualisation as it is burdened with a defect, which grows with the angle of the sector. Neither is the variant able to eliminate skew travel 23 of tubes with shape inaccuracy and vertical movement 15 of tubes, which may be moving vertically 15 (vibration) in an unsuitable way or deviate from the axis and thus enter the scanning plane in a skew fashion. The tube must be in this case guided either so that the vertical movement and skew travel may be negligible or the actual production technology must guarantee ovality below one percent. For accurate measuring of diameters with accuracy of ±0.2 mm and coverage of 50% of profile surface divided into three sectors, this variant is able to measure tubes with diameters up to 470 mm. The frame has a shape of irregular octagon symmetrical around vertical axis when pairs of top and bottom connecting elbows 31 form an angle of 120° and the other two pairs of connecting elbows 33 form an angle of 150°. Three scanners are placed so that they form vertexes of an isosceles triangle whose bottom side is horizontal. Due to this positioning, the bottom half of the frame height (from the axis of measured tube) may be by one third smaller than the top half. In this particular version, one half of frame width (from the measured tube axis to the axis of the tube forming the vertical side of the frame) and the top half of the height (from the measured tube axis to the axis of the tube forming the top side of the frame) equals 904 mm, whereas the bottom half of the frame (from the measured tube axis to the axis of the tube forming the bottom side of the frame) the dimension may be within the range 610-904 mm depending on the available space. Frame thickness is given by the outer diameter of elbows, most often 140 mm. At the place of the scanner, the thickness is given by the size of the housings for scanners (approximately 450 mm). Halves of widths and the top half of the height of the frame may be lowered by 250 mm provided that the scanners are placed on the sides of the frame and not as shown in FIG. 1, where the scanners are placed inside the frame. In such a case the thickness of the frame at the place of scanners increases to 700 mm. Another possibility is to turn the frame by 90°, when the scanners form the vertexes of an equilateral triangle with one vertical side. It is also possible to select a frame with a shape of a regular hexagon when each connecting elbow forms an angle of 120°, and then the half of the frame width of the equilateral version is 904 mm and one half of the height is 1044 mm. Another possible shape of the frame is a regular dodecagon when all elbows are 150°, and in the case of equilateral version one half of the height and width of the frame is 904 mm.

Another exemplary embodiment is a four-scanner tubular frame. Unlike the three-scanner variant, this version is able to eliminate vertical movement of a tube 12 and its shape deformation. At the same time, it is able to function to a limited extent even in the case of a breakdown of one scanner, when measuring is automatically transferred to the three-scanner variant. For accurate measuring of diameters with accuracy of ±0.2 mm and coverage of 50% of profile surface divided into four sectors, this variant is able to measure tubes with diameters between 12 to 645 mm. In the case of tubes with diameters between 12 and 280 mm, it is able to cover more than 82%. For this version the frame has usually the shape of a regular equilateral octagon when all connecting elbows 35 have the angle of 135°, one half of the height is the same as one half of the width, in particular 940 mm. Scanners are placed so that they form vertexes of a square. Width and height halves of the frame may be lowered by 250 mm provided that scanners are placed on the sides of the frame. Frame widths and heights may be also gradually changed within the approximate range of 800-940 mm by selecting various lengths of octagon sides.

The third exemplary embodiment shown in FIG. 2 with indication of a set of rollers of a rolling mill shows a five-scanner tubular frame variant. It is a variant embodiment which is already able to measure tubes 12 in full range with the maximum accuracy of ±0.2 mm with the diameter up to 305 mm (in relation to the tangent, the beam impacts the tube surface at a maximum angle of 45°). It is able to fully scan and measure tubes 12 with the accuracy of ±0.3 mm with the diameter up to 435 mm (in relation to the tangent, the beam impacts the tube surface at a maximum angle of 40°). The span between individual points along the circumference of the profile perpendicular to its axis is dy=1.75 mm. If the centre 24 is known of the nearest fixed guide of the tube (e.g. the centre of the nearest set of rollers of a rolling mill), it is also possible to eliminate the impact of the skew guidance 23 of tubes. The octagonal design of the tubular frame 1 secures even spreading of scanners using the adjustable part 25, which allows turning of scanners in the scanning plane. For measuring of tubes up to the diameter of 305 mm the frame has the shape of an irregular octagon, symmetrical round its vertical axis, when a pair of elbows from top to bottom 31, 33, 32 gradually have the following angles −120°, 150°, 135° and again 135°. The five scanners are placed so that they form vertexes of a five-pointed star. This is achieved by using a special L-shaped adjustable part 25, which allows tilting of scanners so that the centre of the scanning sector of each scanner is pointed at the axis of the measured tube. Due to this positioning, the bottom half of the frame height (from the axis of the measured tube) may be within the range of 847 and 926 mm. In this particular version, one half of the frame width (from the measured tube axis to the axis of the tube forming the vertical side of the frame) equals 989 mm and the top half of the height (from the measured tube axis to the axis of the tube forming the top side of the frame) equals 926 mm.

Other exemplary embodiment is shown in FIG. 3. It is a six-scanner version provided with a secondary set of laser scanners in the second measuring plane. This recommended variant secures measuring of tubes 12 with diameters up to 495 mm with the accuracy of ±0.2 mm (in relation to the tangent, the beam impacts the tube surface at a maximum angle of 45°). The span between individual points along the circumference of the measured tube 12 profile perpendicular to its axis is dy=2 mm. It is able to fully scan and measure tubes with the lower accuracy of ±0.3 mm with diameters up to 585 mm (in relation to the tangent, the beam impacts the tube surface at a maximum angle of 40°). This variant is able to eliminate fully vertical movement of the tube and skew guidance of tubes (offsetting). In order to eliminate skew guidance, it is necessary to know the nearest centre 24 of fixed guidance of the tube (e.g. the centre of the nearest set of rollers of a rolling mill), or the equipment needs to be provided with a secondary measuring/scanning plane 27 with at least three scanners, which is parallel to the primary plane and offset by a known distance (ideally the distance equals the maximum measured tube diameter). Scanners 26 in the second scanning plane may be replaced by laser range finders which measure the distance from the position of the range finder to the ideal centre of the tube. Based on deviations of mutually calibrated range finders the offsetting of the tube is synchronously evaluated in the second plane and is compared to the measured centre of gravity of the scanning plane. The tubular frame 1 with a shape of irregular octagon allows symmetrical spreading of scanners with minimization of frame height. The frame is symmetrical around the vertical axis when pairs of top and bottom connecting elbows 31 form an angle of 120° and the other two pairs of connecting elbows 33 form an angle of 150°. Six scanners are placed so that they form vertexes of a regular isosceles hexagon whose top and bottom sides are horizontal. For measuring of tubes with diameter up to 495 mm, one half of the frame width (from the measured tube axis to the axis of the tube forming the vertical side of the frame) equals 926 mm and one half of the height (from the measured tube axis to the axis of the tube forming the top/bottom side of the frame) is within the range of 890-926 mm. The described version is provided with a secondary measuring plane with three more scanners on the same frame. In principle, every other scanner is doubled so that the additional scanners measure in an offset plane. The second measuring plane significantly changes the frame width at the place of scanner housings depending on the offset of the secondary plane. In the given case, the width is 920 mm with the distance of planes of 520 mm. Another variant is the possibility to implement the secondary plane using another independent frame.

Other exemplary embodiment in terms of number of used scanners may be as follows:

A seven-scanner variant guarantees maximum accuracy of ±0.2 mm for tubes 12 up to the diameter of 620 mm and the span between individual points along the circumference of the profile perpendicular to its axis is dy=2.3 mm. The accuracy achieved for tubes up to 685 mm in diameter is ±0.3 mm. With this variant the frame has usually a shape of unequal angle regular octagon with the connecting elbows forming an angle of 135°. Scanners are fixed to the frame via an L-shaped adjustable part 25 by which the scanners are tilted. In this way it is possible to place the scanners along the circumference of the frame so that they form vertexes of a regular isosceles heptagon with bottom horizontal side. A half of the frame height and width is approximately 910 mm.

The eight-scanner variant guarantees the maximum accuracy of ±0.2 mm for tubes 12 up to the diameter of 700 mm and the span between individual points along the circumference of the profile perpendicular to its axis is dy=2.5 mm. With this variant the frame has most often a shape of isosceles regular octagon with the connecting elbows forming an angle of 135°. Scanners are attached at the halves of sides. One half of the frame width (from the measured tube axis to the axis of the tube forming the vertical side of the frame) and one half of the height (from the measured tube axis to the axis of the tube forming the top/bottom side of the frame) equals 897 mm.

For measuring of greater diameters or for using fewer scanners, it is possible to design other embodiments for which the bottom smallest measured tube diameter is specified. Other variants may be formed when scanner beams with different reach are used and the accuracy also differs then. Numerous variants then may be implemented according to customer's needs. Some selected variants are stated in the following table.

| | | | | | Minimum | Maximum |
|---|---|---|---|---|---|---|
| | | | | | span | span |
| | | | | | between | between |
| | | | | | points | points |
| | | | | | along the | along the |
| | | | | | circumference | circumference |
| Minimal | Maximal | | | Accuracy of | perpendicularly | perpendicularly |
| measured | measured | Scanner | | scanner | on the | on the |
| diameter | diameter | beam range | Number of | measurement | tube axis dy | tube axis dy |
| [mm] | [mm] | [mm] | scanners | [mm] | [mm] | [mm] |
| 6 | 130 | 200-300 | 5 | ±0.2 | 0.16 | 0.66 |
| 50 | 310 | 200-450 | 6 | ±0.3 | 0.33 | 1.32 |
| 100 | 500 | 200-700 | 6 | ±0.4 | 0.54 | 2.15 |
| 100 | 650 | 200-700 | 7 | ±0.4 | 0.58 | 2.36 |
| 300 | 740 | 200-700 | 7 | ±0.4 | 0.67 | 2.67 |
| 600 | 1000 | 200-700 | 8 | ±0.4 | 0.79 | 3.14 |
| 880 | 1300 | 200-700 | 10 | ±0.4 | 0.87 | 3.48 |
| 1220 | 1600 | 200-700 | 12 | ±0.4 | 0.98 | 3.91 |

In terms of its shape, there are some typical variants of the tubular frame 1, which may be achieved by combining the connecting elbows 2 and connecting tubes 3. The shape and dimensions of the tubular frame 1 depend on the measured ranges of diameters and the number of used scanners. For the variant with three or six scanners it is possible to use a regular hexagon with connecting elbows 2 (angle connections) forming an angle of 120°, or even better use an irregular octagon by combining four 150° connecting elbows 2 and four 120° connecting elbows, whereas by turning the tubular frame by 90° other parts of measured tubes 12 are covered. For the variant with four or eight scanners the ideal tubular frame 1 is in the shape of a regular octagon with 135° connecting elbows. In the case of a five-scanner variant, a tubular frame 1 with a shape of an irregular octagon is used with two 150° connecting elbows, two 120° connecting elbows and four 135° connecting elbows. In this case the scanners in the scanning plane are turned so that the centre of the scanning sector of each scanner is aimed at the axis of the measured tube 12. This is achieved by a simple L-shaped adjustable part 25. A ten-scanner variant uses a regular decagonal frame with 144° elbows or a dodecagonal frame when the pairs of top and bottom elbows form an angle of 162° and the remaining are 144° elbows. A twelve scanner variant uses a regular dodecagonal frame with 150° connecting elbows. The design principle allows implementation of a frame with even greater number of scanners—usually even numbers. In such cases the frame is designed especially for the actual application.

Similarly, other frame variants may be designed for polygonal designs.

The exemplary method of measuring of outer dimensions of cross sections and scanning of tubes/bars uses their forward movement during production or on the production conveyor. Measuring is implemented by at least three 2D scanners with steered laser beam, which are evenly spread around tube circumference so that their scanning planes form together a plane perpendicular to the tube axis and each of the scanners is turned so that it covers the given portion of tube/bar profile segment. Together the scanning sectors scan the overall or partial cross section of the tube. Scanners need to be in pairs directed at each other. Scanners project steered laser beams on the tube/bar surface and at individual moments synchronously measure the distance between the coordinate systems of the scanners and the projected points of laser beams on the tube/bar surface. This measurement is synchronously repeated within one deflection cycle so that the whole profile of the tube/bar is scanned point by point in the scanning plane. The deflection cycle is periodically repeated with simultaneous movement of a tube/bar along its axis in which way the whole surface of the tube/bar is gradually scanned. Evaluation of diameters and centre of gravity is carried out based on the points acquired at one moment from all scanners. Following filtration and approximation, the change of the centre of gravity is used for evaluation of executed vertical movement of the profile during one deflection cycle. Based on the knowledge of the vertical movement of the measured section and possibly other measured movement of the centre of gravity in a parallel plane shifted by a known distance, the measured positions of points are converted in order to eliminate vertical movement and possibly skew guidance of tubes/bars. The change of the centre of gravity of the second section in a parallel plane is evaluated by at least three scanners or laser range finders or measuring is replaced by firmly defined point which secures firm guidance of tubes at the given point.

The actual process of analysis and calculation of the measured data is as follows:

Each distance measuring is carried out synchronously on all scanners, which for each cycle renders a group of simultaneously measured distances, which are converted to coordinates of points in the common coordinate system. Following application of a filter, the group of the measured points is used for calculation of diameters and the centre of gravity (centre) of the tube section in the scanning plane.

Firstly, the filter of tangent points (FTP) is applied individually to each scanner. This filter is applied separately in individual coordinate systems of scanners. The used points need to conform to |Δx/Δy|<FTP, where Δx and Δy are distances between two consecutively measured points of one scan in axes x and y. In principle, it defines angle of coverage of a tube by one scanner. As is shown in FIG. 4, mathematically Δx/Δy expresses the slope of a secant passing through two adjacent points. For very close points (Δx/Δy→0), this secant turns into a tangent which may be analytically expressed by circle derivative sin(α)/cos(α)=tg(α)=FTP. For the required maximum angle of tube coverage by the scanner β=2 ·α it is then easy to determine the filter value. For the overall coverage of the tube by four scanners turned by 90° (coverage angle (β=90°), the angle is α=45°. Hence the filtration coefficient)tg(45°=1.

Besides filtration of points placed outside the coverage angle, filter also eliminates erroneously measured solitary points. If the measured point is significantly shifted compared to the previous one (|Δx/Δy|>FTP), it is automatically filtered out, however, it is used for the following comparison. If this point is solitary (e.g. accidental reflection from a dust particle), even the following point will be filtered out because the following relation |Δx/Δy|>FTP will apply again. However, if this error is not accidental, and the following point is near the preceding already filtered out point, then the filter leaves it as it is. In practice, solitary points are filtered out which have been erroneously measured due to e.g. a passing drop of water, dust particle, etc., see FIG. 5. However, if a more substantial object is ascertained, see FIG. 6, on which at least two points are measured, only the first one will be filtered out.

The filter may be also extended by group filtration when the maximum number of points which may be filtered at once are determined based on the following relation |Δx/Δy|>FTP. In the case of this extension, the first point filtered out by the inequation is only marked (the point is marked as suspicious). With the following point, the relation |Δx/Δy|>FTP is checked not only as regards the previous and already suspicious point but also the last conforming point |Δxv/Δyv|>FTP. If the new point is also filtered out by the inequation |Δxv/Δyv|>FTP in relation to the last conforming point, but not filtered out in relation to the preceding point, then even this point is marked as suspicious. In this way the process is repeated for other measured points until the number of successive points exceeds the stipulated limit or unless the filter does not intercept anything until the last valid point. In the first case the marking for the whole group of nonconforming points is retroactively cancelled. In the second case the marking remains and the group of these points is not used for the calculation of the centre of gravity. If there is only one suspicious point in a group, then it is discarded.

After the tangent point filter is applied, the filter of the measured range of diameters is used. The objective of this filter is to filter out the points used for calculation of the centre of gravity which do not correspond to the actually possible measuring on the surface of the measured object. These may be for example loose scales or other objects that passed during measuring in the visual field of scanners. These points are recorded and used for automatic calculation of ovality, however, they are not used for calculation of the centre of gravity. Exclusion of these points form ovality measuring must be decided by the respective operator by a user intervention.

The filter operates by placing a circle for various combination of triplet points (these triplets are selected in the case of more than four-scanner variant in such a way that three adjacent points are never selected) and for this circle a diameter is calculated and a centre defined. If the diameter is outside the determined interval, which is defined as a double of the production tolerances of the tube or the centre is outside the tolerance range, then this triplet of points is marked as suspicious. The points which are marked as suspicious at each calculation are then marked as suspicious permanently and are filtered out for the calculation of the centre of gravity. Filter parameters are determined individually depending on the measured diameter and the maximum possible deviation of the tube which is determined by the production line.

If all commonly measured points by all scanners are conforming, an interpolation curve (most often cubic spline) is then applied to them. In particular, between points of adjacent scanners, interpolation is carried out using y=Ax³+Bx²+Cx+D curve so that transition from one curve to another in measured points is fluent (the first and the second derivative in the common point is the same for both curves). The formed closed curve delimits an area, for which the centre of gravity is subsequently calculated which is the centre of the oval cross section (e.g. tube or bar).

During one deflection cycle of laser beams thus a comprehensive set of groups of points is acquired together with the coordinates of the centre of gravity which represents the overall scanned cross section usually burdened by the cross movement of the tube, see FIG. 7. The function of the cross movement of the tube during scanning of one cross section is determined separately based on approximation of changes of the centres of gravity of the tube in time.

In particular, components of gravity centre coordinates x and y are divided into two separate lines from which tables of values (separately for x and y respectively) are created depending on time t, which represents time when the points were scanned. These table values are approximated according to the selected function (by a line or parabola or hyperbola) which renders two functions of coordinates of the centre of gravity to time fx(t) and fy(t). These functions then represent a function of cross movement of the tube during scanning of one profile.

Elimination of the cross movement as depicted in FIGS. 8 and 9, is realized by shifting individual components of coordinates of measured points in time t so that the coordinate of the centre of gravity fx(t) and fy(t) pass through the beginning. In this way a set of points is acquired of the profile rid of the cross movement with the centre of gravity at the beginning of the coordinate system.

Arbitrarily and for the same time interval, the movement of longitudinally shifted centre of gravity of tube profile is evaluated in one or two other measuring planes parallel to the scanning plane shifted by a known distance I. Evaluation of the centre of gravity in these planes is carried out synchronously with measuring in the scanning plane by at least three scanners using the same method as in the scanning plane, or these are replaced by at least three commonly calibrated laser range finders placed along the circumference of the tube in the measuring plane, so that their beams are directed to the centre of the tube and would measure the distance between the beginning of the laser range finder and the surface of the tube. Again, groups of at least three points of the cross section of a tube are acquired in the measuring plane, of which the function of the change of the centre of gravity to time is evaluated using the same technique as in the scanning plane. The function of a change of shifted centre of gravity to time may be replaced by a firmly defined point located at the intersection of the tube axis and the nearest plane in which no cross movement occurs due to firm guiding of the tube.

Using the functions of cross movement of measured tubes during one cycle of beam deflection, the coordinates of the measured points of the corresponding cross section are converted to eliminate the cross movement and offsetting of tubes during one scanning sequence and thus the actual cross section of a tube is acquired in the scanning plane, which is ideally perpendicular to the tube axis.

Elimination of skew guidance is also carried out for each group of simultaneously measured points separately. First, β angle is ascertained, which represents the deviation of the tube axis from the line ideally perpendicular to the measuring plane. For calculation of this angle, the distance u is determined between coordinates of centre of gravity points T_{A} and T_{B} after projecting into the scanning plane, acquired at the same time t in the scanning plane A and the originally shifted measured plane B due to functions fx(t), fy(t) and fxp(t), fyp(t). Then based on the knowledge of the perpendicular distance of both planes I and the distance of points u, β angle is calculated using tangent theorem β=arc tg(u/l). If β angle is lower than the limit value, then this deviation is regarded as negligible and the elimination of skew guiding is not applied. If it be to the contrary, the coordinate system is shifted and turned so that the beginning of the new coordinate system passes through the centre of gravity T_{A} of the scanning plane and Y axis passes through the centre of gravity T_{B} calculated originally in the shifted plane of functions fxp(t), fyp(t). At the same time, the original coordinates of the measured points P are transformed into the new coordinate system whereas the conversion y_{T}=y·cos(β) is moreover applied to the element y. The given conversion in fact realizes projection of points into the plane perpendicular to the tube axis, which crosses the measuring plane in X axis of the coordinate system at β angle and as such it may be implemented by other relations too. Eventually, the coordinate system turns to the original position and together with that the adjusted coordinates are converted. The process is repeated for each set of simultaneously measured points at t time. Then the points of one passing of beams (one profile) transfer into the common coordinate system so that the partial centres of gravity defined by fx(t) and fy(t) functions pass through the beginning. In this way a set of points is acquired of a profile devoid of the impact of skew guiding of the measured object.

Using the converted points and the knowledge of the centre (centre of gravity) of the profile of one scan, it is easy to calculate diameters and determine the required ovality.

### INDUSTRIAL APPLICABILITY

The method and equipment designed in line with the invention including the corresponding number of scanners may be used for measuring of external shape accuracy of section material or a part thereof of any rod material produced in steel plants or rolling mills, which moves along its axis and passes its whole volume through a plane perpendicular to its axis whereas its vertical movement and possible offsetting is negligible. In the case of rod material whose vertical movement is not negligible, measuring may be applied provided that there is a finite number of surface points symmetrically and arbitrarily placed on the profile surface from which an unambiguous centre of gravity may be determined. For this finite number of points the same number of scanners need to be used.

### REFERENCE MARKS

1. Tubular frame
2. Connecting elbows
3. Connecting tubes
4. Protection housing with water-cooled scanners with an oscillating or rotating laser beam
5. Thermal and screening shield
6. Cooling medium inlet
7. Cooling medium outlet and connection to blowing and cooling of the shield of scanner housings
8. Service air distribution system
9. Liquid cooling medium distribution system
10. Blowing nozzle at optical part of scanner
11. Scanner cooling nozzle
12. Measured tube
13. Direction of tube movement
14. Scanning plane
15. Vertical movement of tube
16. Protection strip
17. Pyrometer
18. Tube travel speed sensor
19. Adjusting elements
20. Sector of oscillating or rotating laser beams of the scanner
21. Scanning segment (border)
22. Measured segment (border)
23. Skew guided tube
24. Centre of the nearest place of fixed guidance of tube (centre of the nearest set of rollers of a rolling mill)
25. Adjustable part
26. Scanners/Laser range finders of the secondary measuring plane (at least three laser range finders)
27. Secondary scanning plane
28. Anchoring elbows
29. Anchoring brackets
30. Sleeves
31. 120° connecting elbow
32. 135° connecting elbows
33. 150° connecting elbows

1. A method of non-contact measuring of outer dimensions of cross sections of metallurgical rod material characterised by the following steps:
at least three uniformly rotating or oscillating laser beams of commonly calibrated and synchronized scanners symmetrically surrounding rod material so that the central positions of beams are directed at the axis of the rod material, repeatedly measuring the distance between the beginning of the coordinate systems of the scanners and the surface of the scanned rod material;
a group of distances measured at the same time is converted to coordinates of points in the common coordinate system;
using the group of points of the common coordinate system, diameters and the centre of gravity (centre) of the rod material in the scanning plane are calculated; based on approximation of changes of centres of gravity of the rod material over time, at least one function of cross movement of the rod material during scanning is determined;
using the function/s of the cross movement of rod material during one cycle of deflection of beams, the coordinates of the measured points of the corresponding cross section are converted to eliminate the cross movement and offsetting of rod material during one scanning sequence in order to acquire the actual cross section of the rod material.

2. The method of non-contact measuring of outer dimensions of cross-sections of rod material according to claim 1 characterised by the fact that in order to eliminate the effect of thermal expansion of rod material, surface temperature of rod material is measured preferably for each segment together with measuring of the distance between the beginning of the coordinate systems of scanners and the surface of the scanned rod material; and the temperature is used for conversion of the dimensions of rod material from hot to cold conditions.

3. A modular frame fitted with at least one scanner and wiring for performing of the method according to claim 1 characterised by the fact that it has a polygonal shape whose vertexes are formed by at least one connecting elbow and at least two anchoring elbows, whereas these connecting elbows and anchoring elbows are connected by connecting arms and these connecting arms are fitted with protective housings with embedded scanners.

4. The modular frame according to claim 3 characterised by the fact that it is provided with a distribution system of at least one cooling medium.

5. The modular frame according to claim 3 characterised by the fact that the anchoring elbows have their longer sides oriented vertically and on these longer sides of anchoring elbows anchoring brackets are fitted.

6. The modular frame according to claim 3 characterised by the fact that an adjustable part is placed between the sleeve and the protective housing.
